(19) United States
(12) Patent Application Publication
(10) Pub. No.: US 2024/0154209 A1
(43) Pub. Date: May 9, 2024

(54) ELECTRODE STRUCTURE

(71) Applicant: TOYOTA JIDOSHA KABUSHIKI KAISHA, Toyota-shi (JP)

(72) Inventor: Shuhei KOYAMA, Toyota-shi (JP)

(73) Assignee: TOYOTA JIDOSHA KABUSHIKI KAISHA, Toyota-shi (JP)

(21) Appl. No.: 18/461,762

(22) Filed: Sep. 6, 2023

(30) Foreign Application Priority Data
Nov. 8, 2022 (JP) 2022-178993

(51) Int. Cl. H01M 10/6566; H01M 10/613; H01M 50/209; H01M 50/264

(52) U.S. Cl. CPC H01M 10/6566; H01M 10/613; H01M 50/209; H01M 50/264

(57) ABSTRACT

A power storage module laminate in which a plurality of power storage modules are stacked via a cooling structure, and a restraining jig for restraining the power storage module laminate by applying pressure to the inside in the stacking direction, wherein the power storage modules adjacent to each other with the cooling structure sandwiched therebetween are electrically connected via the cooling structure, and the cooling structure includes a cooling passage through which a refrigerant flows, and the cooling structure is an electrode structure that is elastically deformable in the stacking direction.

### CROSS-REFERENCE TO RELATED APPLICATION

This application claims priority to Japanese Patent Application No. 2022-178993 filed on Nov. 8, 2022, incorporated herein by reference in its entirety.

### BACKGROUND

### 1. Technical Field

The present application relates to an electrode structure.

### 2. Description of Related Art

Conventionally, there has been known an electrode structure in which a power storage module laminate in which a plurality of power storage modules is stacked via a cooling plate is restrained by using a restraining jig. In such an electrode structure, since the cooling plate is in contact with the power storage modules, even when the power storage modules generate heat by charging and discharging, the heat is transferred to the cooling plate and can be radiated from the cooling plate.

Japanese Unexamined Patent Application Publication No. 2015-76187 (JP 2015-76187 A) and Japanese Unexamined Patent Application Publication No. 2019-21513 (JP 2019-21513 A) disclose such an electrode structure. JP 2015-76187 A and JP 2019-21513 A disclose an electrode structure in which a flow path through which a refrigerant flows is provided in a cooling plate in order to enhance the heat dissipation property of the cooling plate.

### SUMMARY

By the way, in the above-described electrode structure, the power storage module laminate is restrained by applying pressure to the inner side in a stacking direction of the power storage module laminate using the restraining jig. The restraining jig generally includes a restraining plate disposed on both end faces of the power storage module laminate in the stacking direction, and a restraining member (for example, a bolt and a nut) provided at an end portion of the restraining plate, and by restraining the restraining plate with the restraining member, it is possible to apply pressure to the inner side in the stacking direction of the power storage module laminate.

Here, when the restraining pressure is applied to the power storage module laminate by the restraining plate, the pressure to be applied increases as the distance from the restraining member is closer, and the pressure to be applied decreases as the distance from the restraining member is farther. In this case, there is a problem in that a difference in the pressure to be applied between a portion close to the restraining member and a portion far from the restraining member occurs, and the surface pressure distribution of the power storage module laminate is biased. The bias of the surface pressure distribution becomes more pronounced when a large-area power storage module is used.

In response to such a problem, in JP 2019-21513 A, an insulating elastic member (for example, rubber) is disposed between the restraining plate and the power storage module, so that the surface pressure distribution of the power storage module laminate is made uniform. However, an increase in the number of members in the electrode structure is not preferable because this leads to an increase in complexity and size of an apparatus. For example, it is possible to suppress an increase in the size of the apparatus to some extent by reducing the thickness of the elastic member. However, the effect of suppressing the bias of the surface pressure distribution is also reduced.

Therefore, a main object of the present disclosure is to provide an electrode structure capable of suppressing the bias of the surface pressure distribution at the time of restraint and suppressing the increase in the complexity and the size of the apparatus.

The present disclosure provides an electrode structure as one aspect for solving the above issue.

The electrode structure includes:
a power storage module laminate in which a plurality of power storage modules is stacked via a cooling structure; and
a restraining jig for restraining the power storage module laminate by applying pressure to an inner side in a stacking direction, wherein:
the power storage modules facing each other with the cooling structure interposed between the power storage modules are electrically connected via the cooling structure;
the cooling structure includes a cooling passage through which a refrigerant flows; and
the cooling structure is elastically deformable in the stacking direction.

In the above electrode structure, the cooling structure may include two plate-shaped members arranged in the stacking direction, a plurality of support columns connecting the two plate-shaped members, a plurality of deformable support columns that is deformable in the stacking direction and is connected to the two plate-shaped members, and the cooling passage disposed between the two plate-shaped members.

In this case,
the restraining jig may include a restraining plate disposed on both end faces in the stacking direction of the power storage module laminate, and a restraining member for restraining the power storage module laminate so as to sandwich the power storage module laminate in the stacking direction with the restraining plate, and
the restraining member may be disposed at both end portions in a width direction of the restraining plate.
   Further, the support columns may be disposed at a portion other than both end portions in a width direction of a region sandwiched between the two plate-shaped members, and the deformable support columns may be disposed at the both end portions in the width direction of the region.

Alternatively, in the electrode structure,
the restraining jig may include a restraining plate disposed on both end faces in the stacking direction of the power storage module laminate, and a restraining member for restraining the power storage module laminate so as to sandwich the power storage module laminate in the stacking direction with the restraining plate,
the restraining member may be disposed at both end portions in a width direction of the restraining plate,
the cooling structure may include two plate-shaped members arranged in the stacking direction, a plurality of support columns connecting the two plate-shaped members, and the cooling passage disposed between the two plate-shaped members, and
the support columns may be disposed at a portion other than both end portions in a width direction of a region sandwiched between the two plate-shaped members.
   In this case, the cooling passage may be entirely filled with a mesh-shaped metal member.

In the electrode structure, in surface pressure distribution of the power storage module laminate, a difference between maximum surface pressure and minimum surface pressure may be from 40 kPa to 160 kPa.

With the electrode structure according to the present disclosure, since the elastically deformable cooling structure is disposed between the power storage modules in the stacking direction, it is possible to suppress the bias of the surface pressure distribution of the power storage module laminate at the time of restraint while securing the heat dissipation property. Further, it is not necessary to dispose a new member as in JP 2019-21513 A in order to suppress the bias of the surface pressure distribution. Therefore, the number of members can be reduced. Therefore, with the electrode structure according to the present disclosure, it is possible to suppress the increase in the complexity and the size of the apparatus.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a cross-sectional view of an electrode structure 100;

FIG. 2 is an end sectional view of the power storage module 10;

FIG. 3 is a cross-sectional view of the cooling structure 20;

FIG. 4 is an enlarged view of an end portion of the cooling structure 20 in the width direction, and is a view showing a state in which the deformable support columns 23 are elastically deformed in the stacking direction;

FIG. 5A is a cross-sectional view of a cooling structure 120;

FIG. 5B is a cross-sectional view of a cooling structure 220; and

FIG. 5C is a cross-sectional view of a cooling structure 320.

### DETAILED DESCRIPTION OF EMBODIMENTS

Hereinafter, an electrode structure of the present disclosure will be described using an embodiment.

### Electrode Structure 100

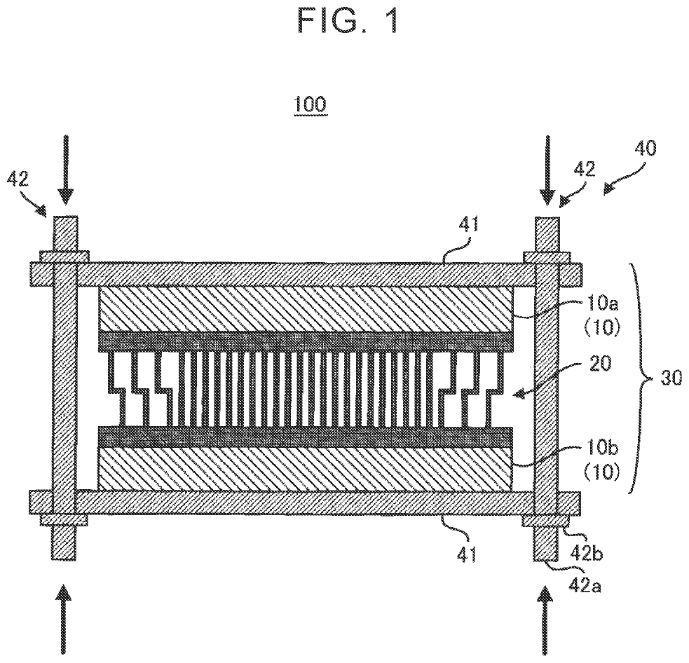

A cross-sectional view of the electrode structure 100 is shown in FIG. 1. In the following, the left-right direction in FIG. 1 will be described as a width direction, the up-down direction will be described as a lamination direction, and the back-side front direction will be described as a length direction.

The electrode structure 100 includes a power storage module laminate 30 in which a plurality of power storage modules 10 are stacked via a cooling structure 20, and a restraining jig 40 that restrains the power storage module laminate 30 by applying pressure to the inside in the stacking direction.

### Power Storage Module 10

As shown in FIG. 1, the electrode structure 100 includes two power storage modules 10. As shown in FIG. 1, of the two power storage modules 10, the power storage module 10 disposed on the upper side in the stacking direction is the first power storage module 10a, and the power storage module 10 disposed on the lower side in the stacking direction is the second power storage module 10b.

The power storage module 10 includes a plurality of electrodes and a plurality of electrolyte layers, and the electrodes and the electrolyte layers are alternately stacked. The power storage module 10 may be a non-aqueous secondary battery or an all-solid-state secondary battery. In addition, the power storage module 10 may be a bipolar-type power storage module from the viewpoint of improving output. The shape of the power storage module 10 is not particularly limited, but may be, for example, a substantially rectangular shape when viewed in the stacking direction. Hereinafter, a case in which the power storage module 10 is a bipolar-type power storage module will be exemplified.

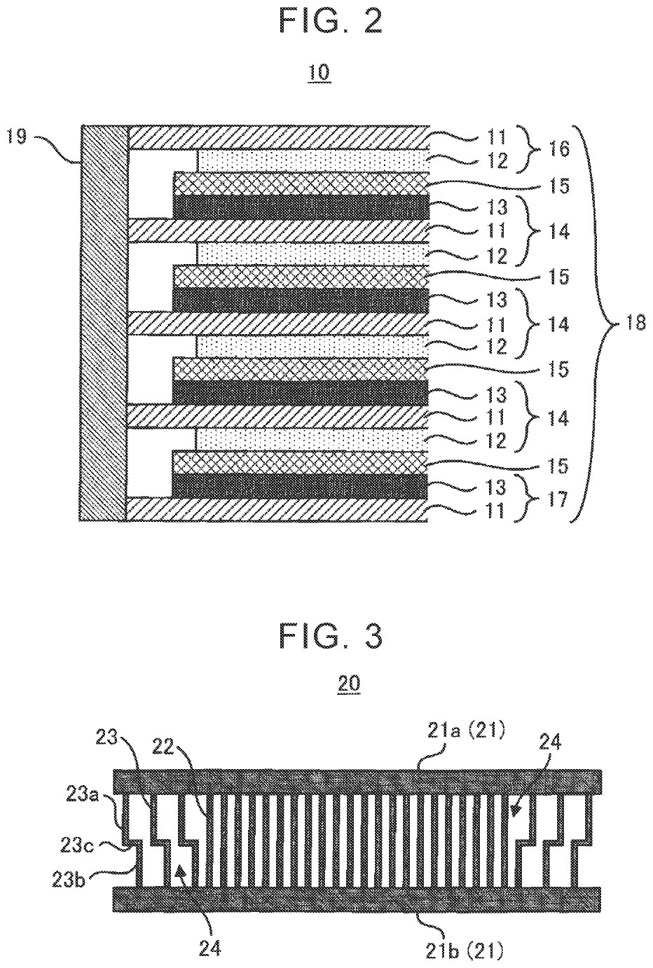

FIG. 2 is an end sectional view of the power storage module 10. As shown in FIG. 2, the power storage module 10 includes an electrode laminate 18 and a sealing member 19 provided on the entire side surface of the electrode laminate 18. Further, the power storage module 10 includes a nonaqueous electrolyte therein.

### Electrode Laminate 18

The electrode laminate 18 includes a plurality of bipolar electrodes 14 and a plurality of separators 15, and the bipolar electrodes 14 and the separators 15 are alternately stacked. The number of the bipolar electrodes 14 and the separators 15 is not particularly limited, and may be appropriately set according to the desired battery performance. The electrode laminate 18 further includes an end portion positive electrode 16 disposed at an upper end portion in the stacking direction, and an end portion negative electrode 17 disposed at a lower end portion in the stacking direction.

The bipolar electrode 14 includes a current collector 11, a positive electrode layer 12 disposed on the lower surface of the current collector 11, and a negative electrode layer 13 disposed on the upper surface of the current collector 11. As described above, the bipolar electrode 14 includes electrode layers of different poles on both surfaces of the current collector 11.

The current collector 11 is a sheet-shaped conductive member. Examples of the current collector 11 include metal foils such as stainless steel, iron, copper, aluminum, titanium, and nickel. The metal foil may be made of an alloy containing two or more of these metals. Further, the metal foil may be subjected to a surface treatment such as a predetermined plating. The current collector 11 may be formed of a plurality of metal foils. In this case, the metal foil may be bonded by an adhesive or the like, or may be bonded by a press or the like. The shape of the current collector 11 is not particularly limited, but may be, for example, a substantially rectangular shape. The thickness of the current collector 11 is not particularly limited, but is, for example, 5 μm or more and 70 μm or less.

The positive electrode layer 12 includes a positive electrode active material. The positive electrode active material is not particularly limited, and may be appropriately selected from known materials according to the desired battery performance. Examples thereof include composite oxides, metallic lithium, and sulfur. Compositions of the composite oxide include, for example, at least one of iron, manganese, titanium, nickel, cobalt, and aluminum, and lithium. Exemplary complex oxides include olivine-type lithium ferric phosphate (LiFePO₄) and the like.

The positive electrode layer 12 may optionally include a conductive aid. The conductive auxiliary agent is not particularly limited, and may be appropriately selected from known materials depending on the desired battery performance. Examples thereof include carbon materials such as acetylene black, carbon black, and graphite.

The positive electrode layer 12 may optionally contain a binder. The binder is not particularly limited, and may be appropriately selected from known materials according to the desired battery performance. Examples thereof include fluorine-containing resins such as polyvinylidene fluoride, polytetrafluoroethylene, and fluorine rubber; thermoplastic resins such as polypropylene and polyethylene; imide-based resins such as polyimide and polyamideimide; acrylic resins such as alkoxysilyl group-containing resins and poly(meth)acrylic acid; styrene-butadiene rubber (SBR); carboxymethylcellulose; alginates such as sodium alginate and ammonium alginate; water-soluble cellulose ester crosslinked products; and starch-acrylic acid graft polymers.

the shape of the positive electrode layer 12 is not particularly limited, and may be a substantially rectangular shape. The thickness of the positive electrode layers 12 is not particularly limited, and is, for example, limn to 1 mm. The area of the positive electrode layer 12 may be smaller than that of the negative electrode layer 13. The content of each material in the positive electrode layer 12 is not particularly limited, and may be appropriately set according to the desired battery performance. The positive electrode layer 12 may include a material other than the above-described material.

the negative electrode layer 13 includes a negative electrode active material. The negative electrode active material is not particularly limited, and may be appropriately selected from known materials according to the desired battery performance. Examples thereof include carbon such as graphite, artificial graphite, highly oriented graphite, mesocarbon microbeads, hard carbon, and soft carbon, a metal compound, an element alloyable with lithium or a compound thereof, and boron-added carbon. Examples of elements that can be alloyed with lithium include silicon and tin.

The negative electrode layer 13 may optionally contain a conductive auxiliary agent. The conductive auxiliary agent is not particularly limited, and may be appropriately selected from known materials depending on the desired battery performance. For example, the conductive auxiliary agent may be appropriately selected from conductive auxiliary agents applicable to the positive electrode layer 12.

The negative electrode layer 13 may optionally contain a binder. The binder is not particularly limited, and may be appropriately selected from known materials according to the desired battery performance. The binder may be appropriately selected from the binders applicable to the positive electrode layer 12, for example.

The shape of the negative electrode layer 13 is not particularly limited, and may be a substantially rectangular shape. The thickness of the negative electrode layers 13 is not particularly limited, and is, for example, 1 μm to 1 mm. The area of the negative electrode layer 13 may be larger than that of the positive electrode layer 12 from the viewpoint of improving the output. The content of each material in the negative electrode layer 13 is not particularly limited, and may be appropriately set according to the desired battery performance. The negative electrode layer 13 may include a material other than the above-described material.

The method of manufacturing the bipolar electrode 14 is not particularly limited, and a known method may be employed. For example, the material constituting the electrode layer (the positive electrode layer 12 or the negative electrode layer 13) may be mixed in a mortar or the like, the electrode layer may be obtained by pressing, and the obtained electrode layer may be disposed on each surface of the current collector 11. Alternatively, the material constituting the electrode layer may be mixed with the solvent to obtain a slurry, and then the slurry may be applied to and dried on the respective surfaces of the current collector 11.

The separator 15 is disposed between adjacent bipolar electrodes 14, between the bipolar electrode 14 and the end portion positive electrode 16, and between the bipolar electrode 14 and the end portion negative electrode 17. The separator 15 is a sheet-like member and is a member for suppressing a short circuit between the electrode layers. The material of the separator 15 is not particularly limited, and examples thereof include porous films and nonwoven fabrics made of polyolefin-based resins such as polyethylene (PE) and polypropylene (PP). The shape of the separator 15 is not particularly limited, and may be a substantially rectangular shape. The thickness of the separators 15 is not particularly limited, and is, for example, 1 μm to 1 mm.

The separator 15 is impregnated with a non-aqueous electrolyte, and thereby functions as an electrolyte layer. The non-aqueous electrolyte includes a non-aqueous solvent and an electrolyte (supporting salt). The non-aqueous solvent is not particularly limited, and examples thereof include cyclic carbonates, cyclic esters, chain carbonates, chain esters, and ethers. The support salt is, for example, a lithium salt. For example, lithium salts can be considered as follows: LiBF₄, LiPF₆, LiN(FSO₂)₂, LiN(SO₂CF₃)₂, LiN(SO₂C₂F₅)₂. A single type of the non-aqueous solvent and the indicator salt may be used, or a mixture of a plurality of types may be used.

The end portion positive electrode 16 includes a current collector 11 and a positive electrode layer 12 disposed on the lower surface of the current collector 11. The end portion positive electrode 16 is disposed at an upper end portion of the electrode laminate 18 in the stacking direction. The end portion positive electrode 16 is laminated on the separator 15 so that the positive electrode layer 12 of the end portion positive electrode 16 and the negative electrode layer 13 of the bipolar electrode 14 face each other.

The end portion negative electrode 17 includes a current collector 11 and a negative electrode layer 13 disposed on the upper surface of the current collector 11. The end portion negative electrode 17 is disposed at a lower end portion of the electrode laminate 18 in the stacking direction. Specifically, the end portion negative electrode 17 is laminated on the separator 15 such that the negative electrode layer 13 of the end portion negative electrode 17 and the positive electrode layer 12 of the bipolar electrode 14 face each other.

The method of manufacturing the end portion positive electrode 16 and the end portion negative electrode 17 is not particularly limited. Known methods may be employed as appropriate. For example, a method similar to the method of manufacturing the bipolar electrode 14 described above may be employed.

### Sealing Member 19

The sealing member 19 is provided on the entire side surface of the electrode laminate 18, and is a member that holds the plurality of bipolar electrodes 14, the end portion positive electrode 16, and the end portion negative electrode 17, and is an insulating resin. The sealing member 19 is also a member for sealing the electrolytic solution in the internal space of the power storage module 10.

The material of the sealing member 19 includes, for example, a resin member exhibiting heat resistance. Examples of the resin member exhibiting heat resistance include polyimide, polypropylene (PP), polyphenylene sulfide (PPS), modified polyphenylene ether (modified PPE), PA66, and the like.

### Method of Manufacturing Power Storage Module 10

A method of manufacturing the power storage module 10 will be described using an example. First, a sheet-shaped sealing member (sealing member sheet) is disposed in advance on each current collector 11. Specifically, the sealing member sheet is disposed so as to surround the outer edge of the current collector 11. Then, the sealing member sheet is bonded to the current collector 11. Next, the bipolar electrode 14, the end portion positive electrode 16, and the end portion negative electrode 17 are manufactured using the current collector 11 in which the sealing member sheet is disposed. The electrode obtained and the separator 15 are laminated to form the electrode laminate 18. Subsequently, a plurality of sealing member sheets provided on the side surface of the electrode laminate 18 are joined to form the sealing member 19. Then, the non-aqueous electrolyte is injected into the internal space of the sealed power storage module 10, whereby the power storage module 10 is obtained.

Alternatively, the sealing member 19 is disposed on each side surface of the electrode laminate 18 by injection molding, and the nonaqueous electrolyte is injected into the internal space of the sealed power storage module 10, whereby the power storage module 10 is obtained.

### Cooling Structure 20

The cooling structure 20 is disposed between the power storage modules 10, and the power storage modules 10 adjacent to each other with the cooling structure 20 interposed therebetween are electrically connected to each other via the cooling structure 20. As a result, the power storage module laminate 30 is entirely electrically connected. In addition, the cooling structure 20 is provided with a cooling passage 24 through which a refrigerant flows. Thus, the heat generated by the charging and discharging of the power storage module 10 is transferred to the cooling structure 20 and can be heat-exchanged with the refrigerant in the cooling passage 24. Therefore, the cooling structure 20 has high heat dissipation and temperature controllability. Further, the cooling structure 20 has a structure that can be elastically deformed in the lamination direction. As a result, it is possible to suppress the deviation of the surface pressure distribution of the power storage module laminate 30 during restraint. As described above, when the bipolar type power storage module 10 is employed, the power storage module 10 may be increased in size in order to improve the output. As the size of the power storage module 10 increases, the deviation of the surface pressure distribution at the time of restraint becomes remarkable, and therefore, the electrode structure 100 is a suitable structure when the battery structure includes a large power storage module 10 (for example, a power storage module having a length in the width direction of 1 m or more and 3 m or less and a length in the length direction of 1 m or more and 3 m or less). A detailed structure of the cooling structure 20 will be described below.

FIG. 3 shows a cross-sectional view of the cooling structure 20. As shown in FIG. 3, the cooling structure 20 includes two plate-shaped members 21 arranged in the lamination direction, a plurality of support columns 22 connecting the two plate-shaped members 21, a plurality of deformable support columns 23 deformable in the lamination direction connected to the two plate-shaped members 21, and a cooling passage 24 disposed between the two plate-shaped members 21.

### Plate-Shaped Member 21

The plate-shaped member 21 is a plate-shaped member having a substantially rectangular shape. The plate-shaped member 21 may be made of a conductive material. Examples thereof include metal materials such as iron, copper, and stainless steel. As shown in FIG. 3, of the two plate-shaped members 21, the plate-shaped member 21 disposed on the upper side in the lamination direction is the first plate-shaped member 21a, and the plate-shaped member 21 disposed on the lower side in the lamination direction is the second plate-shaped member 21b.

The area of the plate-shaped member 21 may be smaller or larger than the area of the power storage module 10. However, as will be described later, since the cooling structure 20 is a member for suppressing non-uniformity of the surface pressure distribution of the power storage module laminate 30 during restraint, the area of the plate-shaped member 21 is equal to or larger than the area of the power storage module 10. Specifically, the area of the plate-shaped member 21 may be 90% or more and 200% or less, or 100% or more and 150% or less of the area of the power storage module 10. The thickness of the plate-shaped member 21 is not particularly limited, but is set to a thickness that can be elastically deformed in the lamination direction by the restraining pressure applied by the restraining jig 40. For example, the thickness of the plate-shaped member 21 may be equal to or greater than 2 mm and equal to or less than 20 mm.

### Support Column 22

The support column 22 is a rod-shaped member extending in the stacking direction, and is connected to two plate-shaped members 21. The plurality of support columns 22 is disposed at portions other than both end portions in the width direction in a region sandwiched between the two plate-shaped members 21. That is, the plurality of support columns 22 is disposed in the center portion in the width direction of the region. As a result, the plurality of support columns 22 supports the two plate-shaped members 21. The support column 22 may be made of a conductive material. For example, a metal material that can be used for the plate-shaped member 21 is exemplified. The upper end portion of the support column 22 is connected to the lower surface of the first plate-shaped member 21a, and the lower end portion is connected to the upper surface of the second plate-shaped member 21b. Therefore, the first plate-shaped member 21a and the second plate-shaped member 21b are electrically connected to each other via the support column 22.

### Deformable Support Column 23

The deformable support column 23 is a rod-shaped member that is elastically deformable in the lamination direction, and is connected to two plate-shaped members 21. As shown in FIG. 3, the deformable support column 23 has an S-shaped leaf spring structure. Specifically, the deformable support column 23 has a partial 23a, 23b extending in the stacking direction and a partial 23c extending in the widthwise direction. The upper end portion of the partial 23a is connected to the first plate-shaped member 21a, and the lower end portion is connected to one end of the partial 23c. Further, the lower end portion of the partial 23b is connected to the second plate-shaped member 21b, and the upper end portion is connected to the other end of the partial 23c. The manner in which the deformable support columns 23 are elastically deformed in the lamination direction will be described later.

The material of the deformable support column 23 is not particularly limited as long as it can be elastically deformed as described later. That is, the deformable support columns 23 may or may not be electrically conductive. This is because the two plate-shaped members 21 are electrically connected to each other via the support columns 22. For example, the material of the deformable support column 23 may be a resin material or a metal material. For ease of manufacture, the material of the deformable support columns 23 may be constructed of a metallic material similar to the support columns 22.

The deformable support column 23 is disposed at both end portions in the width direction in a region sandwiched between the two plate-shaped members 21. The end portion in the width direction in the region sandwiched between the two plate-shaped members 21 is in the range of 10% to 30% from the outer edge in the width direction of the region toward the inner side in the width direction with reference to the length in the width direction of the region (the length in the width direction of the plate-shaped member 21). As will be described later, the range in which the deformable support columns 23 are disposed is appropriately adjusted so as to suppress the deviation of the surface pressure distribution. The degree of elastic deformation of the deformable support columns 23 in the lamination direction may be appropriately set in accordance with the surface pressure distribution at the time of restraint. For example, by changing the material and the thickness of the deformable support column 23, it is possible to appropriately adjust the degree of elastic deformation of the deformable support column 23 in the lamination direction.

### Cooling Passage 24

The cooling passage 24 is a flow path through which the refrigerant can flow, and is formed between the two plate-shaped members 21. Specifically, the cooling passage 24 is a region sandwiched between the two plate-shaped members 21, and is a region other than the support column 22 and the deformable support column 23. That is, the cooling passage 24 is a flow path formed in a gap between the support columns 22, a gap between the deformable support columns 23, a gap between the support columns 22 and the deformable support columns 23, and the like. The refrigerant is usually air. In the case where the cooling passage 24 having an elastic structure in which a portion other than the entrance is sealed is used, an insulating liquid such as a fluorine-based insulating liquid may be used.

### Power Storage Module Laminate 30

The power storage module laminate 30 is a stack of the power storage module 10 and the cooling structure 20. Specifically, the first power storage module 10a is disposed on the upper side of the cooling structure 20 in the stacking direction. The second power storage module 1010b is disposed on the lower side of the cooling structure 20 in the stacking direction. As described above, the cooling structure 20 is sandwiched between the first power storage module 10a and the second power storage module 10b. More specifically, the current collector 11 of the end portion negative electrode 17 of the first power storage module 10a and the upper surface of the first plate-shaped member 21a of the cooling structure 20 are in contact with each other, and the current collector 11 of the end portion positive electrode 16 of the second power storage module 10b and the lower surface of the second plate-shaped member 21b of the cooling structure 20 are in contact with each other. As described above, since the cooling structure 20 has conductivity, the first power storage module 10a and the second power storage module 10b are electrically connected to each other via the cooling structure 20.

### Restraining Jig 40

The restraining jig 40 is a member that restrains the power storage module laminate 30 by applying pressure to the inside in the stacking direction, and ensures contact between the power storage module 10 and the cooling structure 20 and contact between electrodes in the power storage module 10. As shown in FIG. 1, the restraining jig 40 includes a restraining plate 41 disposed on both end surfaces of the stacking direction of the power storage module laminate 30, a restraining member 42 for restraining so as to sandwich the power storage module laminate 30 in the stacking direction with the restraining plate 41 It is equipped with a.

### Restraining Plate 41

The restraining plate 41 has a substantially rectangular shape and has a role of sandwiching the power storage module laminate 30 from the stacking direction. The restraining plate 41 may be subjected to a predetermined insulation treatment in order to prevent the restraining plate from being electrically connected to the power storage module laminate 30. Alternatively, an insulating resin member may be disposed between the restraining plate 41 and the power storage module laminate 30. The area of the restraining plate 41 may be larger than the area of the power storage module 10 disposed on the end face of the power storage module laminate 30. Specifically, the area of the restraining plate 41 may be greater than or equal to 100% and less than or equal to 200% and greater than or equal to 120% and less than or equal to 150% of the area of the power storage module 10.

### Restraining Member 42

The restraining member 42 is disposed at both ends in the width direction of the restraining plate 41, and is a member that restrains the two restraining plates 41 so as to apply pressure to the power storage module laminate 30 toward the inside in the stacking direction. The “end portion in the width direction of the restraining plate 41” means a portion that is an end portion in the width direction of the restraining plate 41 and exceeds the power storage module laminate 30. In other words, the end portion of the restraining plate 41 in the width direction does not overlap with the power storage module laminate 30 in the stacking direction.

The configuration of the restraining member 42 is not particularly limited as long as the restraining pressure toward the inner side in the stacking direction can be applied to the power storage module laminate 30 sandwiched between the restraining plates 41. In FIG. 1, a restraining member 42 having a bolt 42a and a nut 42b is illustrated. The restraining pressure applied to the power storage module laminate 30 can be adjusted by adjusting the tightening strength of the nut 42b.

### Suppression of Deviation of Surface Pressure Distribution

As described above, the restraining jig 40 has the restraining members 42 at both ends in the width direction of the restraining plate 41, and the restraining members 42 apply pressure toward the inside in the stacking direction to the power storage module laminate 30. Therefore, in the power storage module laminate 30, a higher surface pressure is applied as the position is closer to the restraining member 42, and a lower surface pressure is applied as the position is farther. Therefore, when a stacked body in which only the power storage module 10 is stacked is used, the surface pressure distribution thereof is biased.

Therefore, in the electrode structure 100, the power storage module laminate 30 in which the plurality of power storage modules 10 are stacked via the cooling structure 20 is used. As described above, the cooling structure 20 includes the deformable support columns 23 at both end portions in the width direction of the region sandwiched between the two plate-shaped members 21. The deformable support column 23 has a leaf spring structure and is elastically deformable in the lamination direction. Therefore, both end portions of the cooling structure 20 in the width direction are also elastically deformable in the lamination direction.

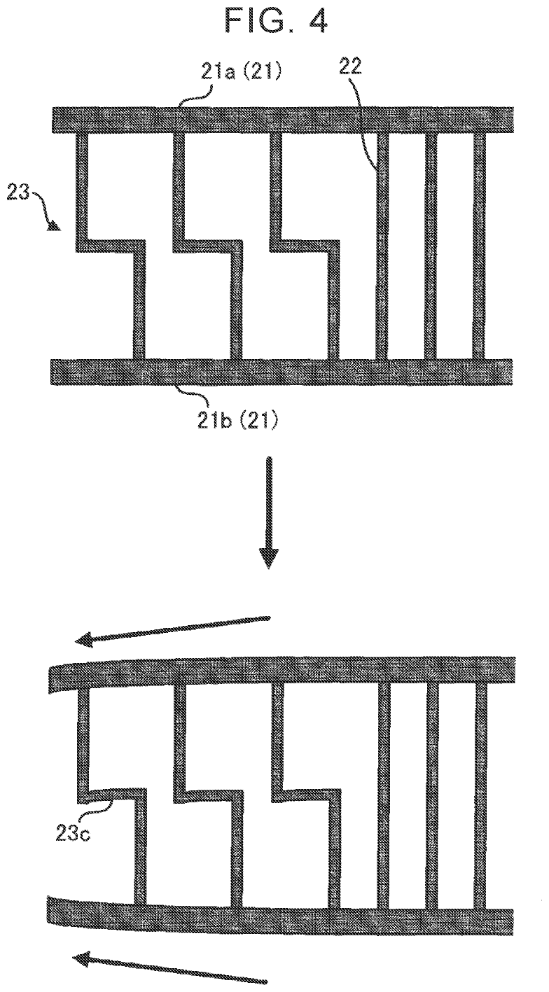

FIG. 4 is an enlarged view of an end portion of the cooling structure 20 in the width direction, and shows a state in which the deformable support column 23 are elastically deformed in the lamination direction. FIG. 4 shows the state of the cooling structure 20 before and after the restraint pressure is applied by the restraining jig 40. When the restraining pressure is applied by the restraining jig 40, the cooling structure 20 is elastically deformed as shown in the upper drawing to the lower drawing in FIG. 4. Specifically, since the end portion of the plate-shaped member 21 in the width direction is given a restraining pressure higher than that of the central portion, it is elastically deformed so as to warp toward the inner side in the lamination direction. Accordingly, the partial 23c of the deformable support column 23 is elastically deformed so as to warp. The support column 22 does not elastically deform in the lamination direction, and thus maintains its shape. Therefore, when the cooling structure 20 as a whole is viewed, both end portions of the cooling structure 20 in the width direction are elastically deformed in the lamination direction.

Since the electrode structure 100 includes the cooling structure 20, even if the restraining pressure is applied to the power storage module laminate 30 by the restraining jig 40, the bias of the surface pressure distribution can be suppressed by the elastic deformation of the cooling structure 20 in the power storage module laminate 30.

The surface pressure distribution of the power storage module laminate 30 can be measured by using a known surface pressure distribution measuring apparatus. Specifically, the surface pressure distribution of the power storage module laminate 30 can be measured by inserting a surface pressure distribution sensor between the restraining plate 41 and the power storage module laminate 30 and applying the restraint pressure in this state.

The suppression of the deviation of the surface pressure distribution, which is the effect of the electrode structure 100, can be confirmed by comparing the case where the cooling structure 20 is provided with and the case where the cooling structure is not provided. Specifically, the surface pressure distributions of the two are compared, and it is determined that the deviation of the surface pressure distribution is suppressed when the difference between the maximum surface pressure and the minimum surface pressure becomes small in the surface pressure distribution. When the difference between the largest surface pressure and the smallest surface pressure is within 160 kPa from 40 kPa, it can be determined that the deviation of the surface pressure distribution is remarkably suppressed.

### Reducing the Complexity and Size of Equipment

As described above, the cooling structure 20 has heat dissipation and elastically deformable properties, and is a member that achieves both a role as a conventional cooling plate and a role as an elastic member. Therefore, in the electrode structure 100, since it is not necessary to use these members separately, it is possible to suppress complication and increase in size of the apparatus.

### Other Forms of Cooling Structure 20

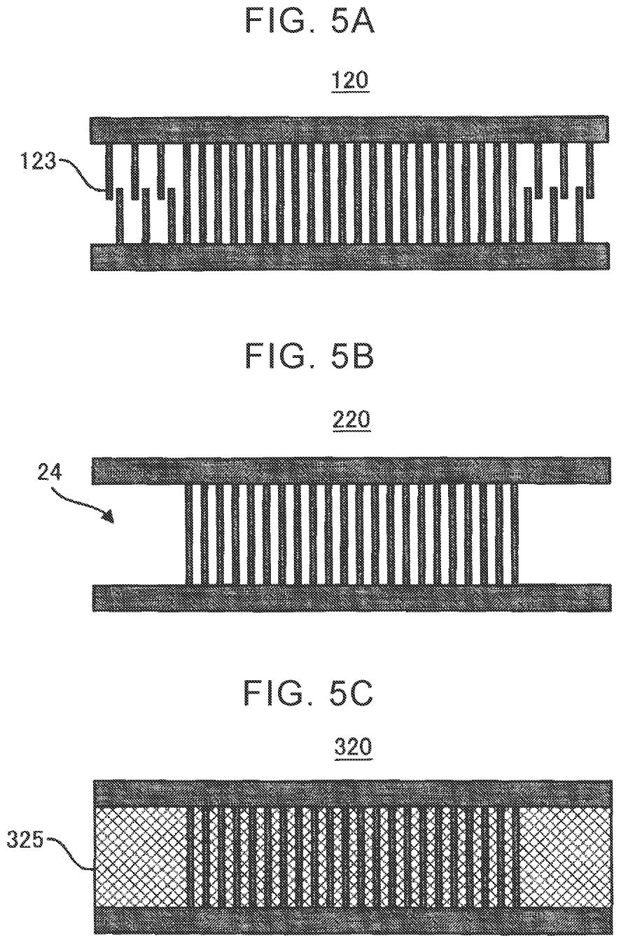

Other aspects of the cooling structure 20 are described. In FIGS. 5A, 5B, and 5C, cross-sectional views of the cooling structures 120, 220, and 320 are shown, respectively.

First, the cooling structure 120 shown in FIG. 5A will be described. The cooling structure 120 has the same configuration as the cooling structure 20, except that the deformable support column 23 is changed to the deformable support column 123. The deformable support column 123 has a configuration in which a partial 23c is removed from the deformable support column 23, and is deformable in the stacking direction. Further, even when the end portion of the plate-shaped member 21 in the width direction is elastically deformed due to the restraining pressure, the deformable support column 123 does not hinder the deformation. Therefore, the degree of elastic deformation of the cooling structure 120 depends on the degree of elastic deformation of the plate-shaped member 21. When the cooling structure 120 and the cooling structure 20 are compared, it is more difficult to adjust the degree of elastic deformation of the cooling structure 120 in that the cooling structure does not include the deformable support column 23 having the leaf spring structure. On the other hand, the cooling structure 120 sufficiently has an effect of suppressing the deviation of the surface pressure distribution of the power storage module laminate.

Next, the cooling structure 220 shown in FIG. 5B will be described. The cooling structure 220 has the same configuration as the cooling structure 20 except that the deformable support columns 23 are removed from the cooling structure 20. Like the cooling structure 120, the cooling structure 220 does not prevent the elastic deformation of the end portion of the plate-shaped member 21 in the width direction due to the restraining pressure. Therefore, the cooling structure 220 has an effect of suppressing the deviation of the surface pressure distribution of the power storage module laminate, similarly to the cooling structure 120. Further, since the cooling structure 220 does not include a deformable support column, the manufacturing cost can be reduced.

The cooling structure 320 shown in FIG. 5C is now described. The cooling structure 320 has a structure in which the entire cooling passage 24 of the cooling structure 220 is filled with a mesh-shaped metal member 325. The material of the mesh-shaped metal member 325 is not particularly limited, and examples thereof include iron, copper, and stainless steel. Since the mesh-like metal member 325 has elasticity, the role of the deformable support column 23 is replaced. Therefore, the cooling structure 320 has an effect of suppressing the deviation of the surface pressure distribution of the power storage module laminate, similarly to the cooling structure 120.

As shown in FIG. 5C, the metal member 325 is filled in the entire cooling passage 24, but may be disposed only at both widthwise end portions in the area sandwiched between the two plate-shaped members. However, when the metal member 325 is disposed only at both end portions in the width direction in the region, the region where the metal member 325 is disposed is less likely to circulate the refrigerant than the region where it is not disposed. Therefore, the heat dissipation property of the cooling structure 320 may be lowered. In this respect, the metal member 325 is preferably filled in the entire cooling passage 24. However, this does not apply to the case where the electrode structure is provided with a mechanism/apparatus capable of controlling the flow of the refrigerant.

### Supplement

Although two power storage module 10a, 10b have been used in one embodiment, the disclosed electrode structure is not limited thereto. The number of power storage modules may be two or more. The number of power storage modules may be appropriately set according to the desired performance. When the number of the power storage modules is 3 or more, the cooling structure may be disposed between at least one of the stacked power storage modules, or may be disposed between the stacked power storage modules.

In one embodiment, in the region sandwiched between the two plate-shaped members 21, the support columns 22 are disposed at the center portion in the width direction, and the deformable support columns are disposed at both end portions in the width direction. This is because the restraining member 42 is disposed at both end portions in the width direction of the restraining plate 41. However, in the electrode structure of the present disclosure, the position of the restraining member is not limited to both end portions in the width direction of the restraining plate, and may be any position capable of applying the restraining pressure to the power storage module laminate. Therefore, in the electrode structure of the present disclosure, the positions of the support columns and the deformable support columns are not limited, and may be appropriately set in accordance with the deviation of the surface pressure distribution of the power storage module laminate.

The electrode structure of the present disclosure has been described with reference to an embodiment. According to the electrode structure of the present disclosure, it is possible to suppress the deviation of the surface pressure distribution of the power storage module laminate at the time of restraint. Further, in order to suppress the deviation of the surface pressure distribution, it is not necessary to dispose a new member as in JP-A-2019-21513. Therefore, the number of members can be reduced. Therefore, according to the electrode structure of the present disclosure, it is possible to suppress complication and enlargement of the device.

What is claimed is:

1. An electrode structure comprising:
a power storage module laminate in which a plurality of power storage modules is stacked via a cooling structure; and
a restraining jig for restraining the power storage module laminate by applying pressure to an inner side in a stacking direction, wherein:
the power storage modules facing each other with the cooling structure interposed between the power storage modules are electrically connected via the cooling structure;
the cooling structure includes a cooling passage through which a refrigerant flows; and
the cooling structure is elastically deformable in the stacking direction.

2. The electrode structure according to claim 1, wherein the cooling structure includes two plate-shaped members arranged in the stacking direction, a plurality of support columns connecting the two plate-shaped members, a plurality of deformable support columns that is deformable in the stacking direction and is connected to the two plate-shaped members, and the cooling passage disposed between the two plate-shaped members.

3. The electrode structure according to claim 2, wherein:
the restraining jig includes a restraining plate disposed on both end faces in the stacking direction of the power storage module laminate, and a restraining member for restraining the power storage module laminate so as to sandwich the power storage module laminate in the stacking direction with the restraining plate;
the restraining member is disposed at both end portions in a width direction of the restraining plate; and
in the cooling structure, the support columns are disposed at a portion other than both end portions in a width direction of a region sandwiched between the two plate-shaped members, and the deformable support columns are disposed at the both end portions in the width direction of the region.

4. The electrode structure according to claim 1, wherein:
the restraining jig includes a restraining plate disposed on both end faces in the stacking direction of the power storage module laminate, and a restraining member for restraining the power storage module laminate so as to sandwich the power storage module laminate in the stacking direction with the restraining plate;
the restraining member is disposed at both end portions in a width direction of the restraining plate;
the cooling structure includes two plate-shaped members arranged in the stacking direction, a plurality of support columns connecting the two plate-shaped members, and the cooling passage disposed between the two plate-shaped members; and
the support columns are disposed at a portion other than both end portions in a width direction of a region sandwiched between the two plate-shaped members.

5. The electrode structure according to claim 4, wherein the cooling passage is entirely filled with a mesh-shaped metal member.

6. The electrode structure according to claim 1, wherein in surface pressure distribution of the power storage module laminate, a difference between maximum surface pressure and minimum surface pressure is from 40 kPa to 160 kPa.
